(19) United States
(12) Patent Application Publication
(10) Pub. No.: US 2025/0069084 A1
(43) Pub. Date: Feb. 27, 2025

(54) HIGH-RISK VIRTUAL ASSET WALLET ADDRESS MANAGEMENT APPARATUS, AND METHOD FOR PROVIDING HIGH-RISK WALLET ADDRESS QUERY SERVICE USING THE SAME

(71) Applicant: BONANZA FACTORY CO., LTD., Seoul (KR)

(72) Inventors: Hye Yeon PARK, Seoul (KR); Han Joo LEE, Seoul (KR); Kyu Hwan JUNG, Seoul (KR); Hyo Yeon JEON, Seoul (KR)

(21) Appl. No.: 18/945,543

(22) Filed: Nov. 13, 2024

Related U.S. Application Data
(63) Continuation of application No. PCT/KR2024/006941, filed on May 22, 2024.

(30) Foreign Application Priority Data
May 24, 2023 (KR) 10-2023-0066635

(51) Int. Cl. G06Q 20/40; G06Q 20/36

(52) U.S. Cl. CPC G06Q 20/4016; G06Q 20/36

(57) ABSTRACT

A virtual asset wallet address management apparatus and a method of providing a wallet address query service using the same are disclosed. The wallet address management apparatus according to an embodiment of the present disclosure includes: a data collector configured to collect and store a plurality of risky wallet addresses from a plurality of virtual asset exchange servers; and a data manager configured to store the plurality of collected risky wallet addresses in a database, and upon receiving a query for a specific wallet address from a specific virtual asset exchange server among the plurality of virtual asset exchange servers, provide the specific virtual asset exchange server with information on whether the specific wallet address is risky by querying the plurality of registered risky wallet addresses from the plurality of virtual asset exchange servers.

### TECHNICAL FIELD

The present disclosure relates to financial transactions and security technology.

### BACKGROUND ART

Virtual assets refer to assets that do not have a physical form, like paper money or coins, and are traded online. A virtual asset exchange functionally connects people who have virtual assets with those who wish to buy the virtual assets, facilitating direct buying and selling of the virtual assets. First, to trade virtual assets, a client must register on the exchange's website and transfer funds to a verified account. The transferred funds may then be used to buy and sell virtual assets and, using the personal e-wallet provided by the virtual asset exchange, virtual assets may be sent to or received from other e-wallet addresses.

Generally, virtual asset e-wallets may store cryptographic keys and access virtual assets through identity verification using the stored cryptographic keys (or private keys). In addition, these virtual asset e-wallets allow access to virtual assets to send or receive the virtual assets between users and perform transactions. Furthermore, when a virtual asset e-wallet is generated, a wallet address is generated, and this wallet address may be used to send virtual assets to other users or make transactions.

However, when a client wants to transfer virtual assets held in a virtual asset exchange e-wallet to another virtual asset exchange, the risk of a recipient's e-wallet cannot be assessed, so it is challenging to prevent clients from transferring virtual assets to e-wallets associated with criminal activities.

Therefore, virtual asset exchanges need practical technology to assess the risk of the e-wallet addresses used by clients.

### DETAILED DESCRIPTION OF INVENTION

### Technical Problems

According to one embodiment, the present disclosure provides a high-risk virtual asset wallet address management apparatus and a method for providing a high-risk wallet address query service by checking and notifying a risk status of a virtual asset wallet address used when a client of a virtual asset exchange requests the transfer of a virtual asset, thereby preventing fraudulent use of high-risk wallet addresses or wallet addresses detected with anomalous transactions and protecting the exchange.

### Technical Solution

A high-risk virtual asset wallet address database management apparatus according to an embodiment of the present disclosure includes: a data collector configured to collect a plurality of risky wallet addresses from a plurality of virtual asset exchange servers; and a data manager configured to store the plurality of collected risky wallet addresses in a database, and upon receiving a query request for a specific wallet address from a specific virtual asset exchange server, to determine whether the specific wallet address is risky by querying the database for the plurality of risky wallet addresses collected from various virtual asset exchange servers, and to respond to the specific virtual asset exchange server with whether the specific wallet address is risky.

The data collector may collect a plurality of risky wallet addresses from a plurality of financial institution servers and a plurality of public institution servers, and the data manager may store the plurality of collected risky wallet addresses in the database, and upon receiving a query for a specific wallet address from a specific virtual asset exchange server, determine whether the specific wallet address is risky by querying the database for the plurality of risky wallet addresses collected from the plurality of financial institution servers and the plurality of public institution servers, and respond to the specific virtual asset exchange server with whether the specific wallet address is risky.

The data collector may collect a plurality of high-risk wallet addresses from a plurality of web pages including at least one of a surface web, a deep web, a dark web, and a social networking service (SNS) through web crawling, and the data manager may store the plurality of collected risky wallet addresses in the database, and upon receiving a query for a specific wallet address from a specific virtual asset exchange server, determine whether the specific wallet address is risky by querying the database for the plurality of risky wallet addresses collected from the plurality of web pages, and respond to the specific virtual asset exchange server with whether the specific wallet address is risky.

The data collector may include: a blockchain explorer configured to collect wallet information from a selected wallet address, including transaction history, transaction volume, transaction recipient, and transaction time stored in block chains; and a web crawler configured to collect wallet addresses exposed on web pages.

The data collector may define risky wallet address categories and distinguish methods for collecting risky wallet addresses so that a first category involves collecting risky wallet addresses through a web crawler, a second category involves collecting risky wallet addresses by analyzing transaction history of the collected wallet addresses, and a third category involves collecting risky wallet addresses by accessing public institution websites.

The wallet address management apparatus may further include a data analyzer configured to analyze a plurality of wallet addresses collected by the data collector and filter out risky wallet addresses.

The data analyzer may include a first data analyzer configured to analyze risk behavior patterns using the collected wallet address information, classify primary risky wallet addresses based on the analyzed risk behavior patterns, categorize the classified wallet addresses by risk level, and store the categorized primary risky wallet addresses in the database.

The data analyzer may include a first data analyzer configured to extract primary risky wallet addresses using search keywords for respective risky wallet address categories, including blacklist, cybercrime, financial crime, and other crime categories, and store the classified primary risky wallet addresses in the database.

The first data analyzer may define risk assessment criteria by applying relevant laws and regulations of related institutions based on suspected crime types associated with the extracted primary risky wallet addresses and, based on the risk assessment criteria, quantify risks of the wallet addresses and assign weights to the wallet addresses.

The data analyzer may include a second data analyzer configured to load primary risky wallet addresses from the database, analyze transaction history information of the primary risky wallet addresses, and extract secondary risky wallet addresses using a risk prediction model.

A method of providing a high-risk wallet address query service according to another example includes: receiving requests to register a risky wallet address from a plurality of virtual asset exchange servers and registering risky wallet addresses; through web crawling, extracting primary risky wallet addresses using search keywords for risky wallet address categories; storing and registering the extracted primary risky wallet addresses in a database; and loading the primary risky wallet addresses registered in the database, analyzing transaction history information of the primary risky wallet addresses, extracting secondary risky wallet addresses using a risk prediction model, and storing the extracted secondary risky wallet addresses in the database.

A method of providing a high-risk wallet address query service according to yet another example includes: receiving requests to register a risky wallet address from a plurality of virtual asset exchange servers and registering risky wallet addresses; receiving a query request for a specific wallet address from a specific virtual asset exchange server; determining whether the specific risky wallet address is risky, by querying the registered risky wallet addresses from the plurality of virtual asset exchange servers; and responding to the specific virtual asset exchange server with whether the specific wallet address is risky.

The method may further include receiving requests to register a risky wallet address from a plurality of public institution servers and a plurality of financial institution servers and registering risky wallet addresses, and in determining whether the specific wallet address is risky, the registered risky wallet addresses from the plurality of public institution servers and the plurality of financial institution servers may be queried to determine whether the specific wallet address is risky.

The method may further include collecting risky wallet addresses through web crawling, and in determining whether the specific wallet address is risky, the risky wallet addresses collected through the web crawling may be queried to determine whether the specific wallet address is risky.

The method may further include extracting primary risky wallet addresses using search keywords for the respective risky wallet address categories through web crawling; and storing and registering the extracted primary risky wallet addresses in the database, and in determining whether the specific wallet address is risky, the primary risky wallet addresses stored in the database may be queried to determine whether the specific wallet address is risky.

The method may further include: extract secondary risky wallet addresses by analyzing transaction history of the registered primary risky wallet addresses, and storing the extracted secondary risky wallet addresses in the database, and in determining whether the specific wallet address is risky, the secondary risky wallet addresses stored in the database may be queried to determine whether the specific wallet address is risky.

### Effect of Invention

In a high-risk virtual asset wallet address management apparatus and a method of providing a high-risk wallet address query service using the same according to one embodiment, it is possible to query a risk status of a wallet address for transferring a virtual asset upon a request for the transfer of the virtual asset from a client, and to provide a query result.

Accordingly, it is possible to preemptively prevent the fraudulent use of an e-wallet address detected with an anomalous transaction and to protect a virtual asset exchange from financial crime risks. At this point, the wallet address management apparatus may manage risky wallet addresses registered not only by the virtual asset exchange used by the client but also by all virtual asset exchanges affiliated with the apparatus and then notify these virtual asset exchanges of the risk statuses of the risky wallet addresses, thereby providing better protection against financial crime risks.

In addition, the high-risk wallet address management apparatus according to one embodiment may collect risky wallet addresses through web crawling from a dark web, a surface web, a social networking service (SNS), etc. In addition, since risky wallet addresses can be collected from a plurality of public institutions, a plurality of financial institutions, etc., and notified to virtual asset exchanges, it is possible to protect the virtual asset exchanges better against financial crime risks.

Furthermore, the wallet address management apparatus according to one embodiment may extract primary risky wallet addresses using a search keyword for each risky wallet address category, and extract secondary risky wallet addresses through analysis of transaction history information of the primary risky wallet addresses and a risk prediction model. Accordingly, due to the risky wallet address analysis process, it is possible to extract risky wallet addresses more accurately.

### BRIEF DESCRIPTION OF THE DRAWING

FIG. 1 is a diagram illustrating the configuration of a high-risk virtual asset wallet address management system according to an embodiment of the present disclosure;

FIG. 2 is a diagram illustrating the detailed configuration of the wallet address management apparatus of FIG. 1 according to an embodiment of the present disclosure;

FIG. 3 is a diagram illustrating the detailed configuration of a processor according to an embodiment of the present disclosure;

FIG. 4 is a diagram illustrating a process of extracting a primary risky wallet address by analyzing information collected through a blockchain explorer according to an embodiment of the present disclosure;

FIG. 5 is a diagram illustrating a process of extracting a primary risky wallet address by analyzing information collected through a web crawler according to an embodiment of the present disclosure;

FIG. 6 is a diagram illustrating a process of extracting a secondary risky wallet address according to an embodiment of the present disclosure;

FIG. 7 is a diagram illustrating a high-risk wallet address registration and deregistration process according to an embodiment of the present disclosure;

FIG. 8 is a diagram illustrating the flow of a method for providing a high-risk wallet address query service according to an embodiment of the present disclosure.

### BEST MODE FOR CARRYING OUT THE INVENTION

The aforementioned objects, other objects, features and advantages of the present disclosure will be easily understood through the following preferred embodiments related to the accompanying drawings. However, the present disclosure is not limited to the embodiments described herein and may be implemented in other forms. Rather, these embodiments are provided so that this disclosure is thorough and complete, and will fully convey the scope of the present disclosure to those skilled in the art.

In this specification, when a component is referred to as being on another component, it means that it may be formed directly on the other component or that a third component may be interposed therebetween.

In this specification, if terms such as ‘first’ and ‘second’ are used to describe components, these components should not be limited by such terms. These terms are merely used to distinguish one component from another. The exemplary embodiments include their complementary embodiments.

Also, it will be understood that when a first element (or first component) is referred to as being operated or executed “on” a second element (or second component), the first element (or first component) can be operated or executed in an environment where the second element (second component) is operated or executed or can be operated or executed by interacting with the second element (second component) directly or indirectly.

It will be understood that when an element, component, apparatus or system is referred to as comprising a component consisting of a program or software, the element, component, apparatus or system can comprise hardware (for example, a memory, a central processing unit (CPU), etc.) for executing or operating the program or software or another program or software (for example, an operating system (OS), a driver for driving a hardware, etc.), unless the context clearly indicates otherwise.

Also, it will be understood that an element (or component) can be realized by software, hardware, or software and hardware, unless the context clearly indicates otherwise.

Additionally, the terms used in this specification are for describing embodiments and are not intended to limit the present disclosure. In this specification, the singular forms are intended to include the plural forms as well, unless the context clearly indicates otherwise. It will be further understood that the terms “comprises” and/or “comprising,” when used in this specification, do not preclude the presence or addition of one or more other components.

In the following description of particular embodiments, many details are provided to describe the embodiments in further detail and to aid in understanding the present disclosure. However, those of ordinary skill in the art will appreciate that the embodiments could be used without such details.

In some cases, descriptions that are well known but have no direct relationship to the present disclosure will be omitted to prevent the present disclosure from being obscured.

Hereinafter, embodiments of the present specification will be described with reference to the accompanying drawings. A detailed explanation will focus on the parts necessary to understand the operations and functions according to the present specification. In describing the embodiments of this specification, description will be omitted for technical content that is well known in the technical field to which this specification belongs, and that is not directly related to this specification. This is to convey the gist of this specification more clearly without obscuring it by omitting unnecessary explanation.

Additionally, when describing the components of the present specification, different reference numerals may be assigned to components with the same name depending on the drawings, and the same reference numerals may be assigned to different drawings. However, even in this case, it does not mean that the corresponding component has different functions depending on the embodiment or that it has the same function in different embodiments, and the function of each component is different from the corresponding embodiment. The judgment should be made based on the description of each component in.

In this specification, each component indicates that it can be separated functionally and/or logically, and does not necessarily mean that each component is divided into a separate physical device or written in a separate code. The average expert will be able to infer easily.

Additionally, each component in this specification may mean a functional and structural combination of hardware for carrying out the technical idea of the present disclosure and software for driving the hardware. For example, each component may denote a logical unit of a given code and a given hardware resource for performing the code, and it does not necessarily mean a physically connected code or refer to one type of hardware, as can be easily inferred by an average expert in the technical field of the present disclosure.

In an embodiment of the present disclosure, transmitting a virtual asset can be used to mean a transaction in which a virtual asset is traded on a blockchain network.

Hereinafter, embodiments of the present disclosure will be described with reference to the drawings.

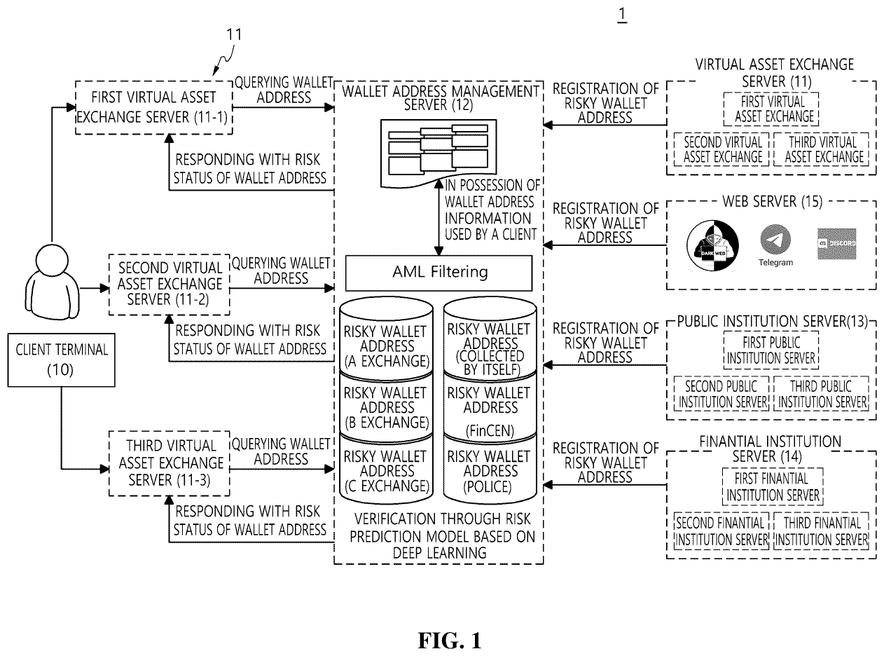

FIG. 1 is a diagram illustrating the configuration of a virtual asset wallet address management system according to an embodiment of the present disclosure.

Referring to FIG. 1, a virtual asset wallet address management system 1 includes a client terminal 10, a plurality of virtual asset exchange servers 11, a wallet address management apparatus 12, a plurality of public institution servers 13, a plurality of financial institution servers 14, and a plurality of web servers 15.

The wallet address management apparatus 12 collects and manages wallet addresses for transmitting virtual assets. The wallet address management apparatus 12 collects and manages high-risk wallet addresses suspected of money laundering or criminal activity, and upon a request from a specific virtual asset exchange server 11, the wallet address management apparatus 12 queries a risk and provides a query result.

If a wallet address to which a client wishes to transfer a virtual asset corresponds to a risky wallet address when the client makes a virtual asset transfer request through the client terminal 10, each asset exchange server 11 may refuse the client's virtual asset transfer request.

The wallet address management apparatus 12 collects wallet addresses provided from the plurality of virtual asset exchange servers 11, the plurality of public institution servers 13, the plurality of financial institution servers 14, and the plurality of web servers 15. In FIG. 1, the number of servers is limited to three, but this is merely to help understand the description, and this is not restrictive.

Examples of public institutions include the Federation of Banks, the National Police Agency, the Financial Supervisory Service, the National Tax Service, the Customs Service, the Ministry of Strategy and Finance, the Ministry of Justice, the Financial Services Commission, etc. Examples of financial institutions include banks and securities companies. Examples of web pages provided by the web servers 13 include a surface web, a deep web, a dark web, an SNS, etc. Examples of the SNS include Telegram, Discord, etc.

When a query request for a wallet address is received from a specific virtual asset exchange server, for example, a first virtual asset exchange server 11-1, the wallet address management apparatus 12 may query registered wallet addresses not only from the first virtual asset exchange server 11-1 but also from other virtual asset exchange servers 11-2 and 11-3 connected to the wallet address management apparatus 12 and then notify a risk status of the specific wallet address.

For example, the customer terminal 10 requests the first virtual asset exchange server 11-1 to transfer a virtual asset. Then, the first virtual asset exchange server 11-1 queries the wallet address management apparatus 12 to determine whether a specific wallet address for transferring the virtual asset is risky. Next, the wallet address management apparatus 12 determines whether the specific wallet address is risky by querying a database to check the registered wallet addresses stored from other virtual asset exchange servers 11-2 and 11-3, and then provides a result of the determination to the first virtual asset exchange server 11-1.

The client terminal 10 connects to the virtual asset exchange server 11 to receive services of the virtual asset exchange server 11. The client is the user of the client terminal 10, who uses the services of the virtual asset exchange server 11. The client terminal 10 includes all terminals available to the client, particularly mobile phones and PC terminals.

The wallet address management apparatus 12 is connected to the virtual asset exchange server 11 to manage the transfer to the client's virtual asset exchange server 11.

The financial institution server 14 handles the reporting of suspicious transactions of illegal assets, reporting of large cash transactions, client identification, and provision of information to investigative agencies.

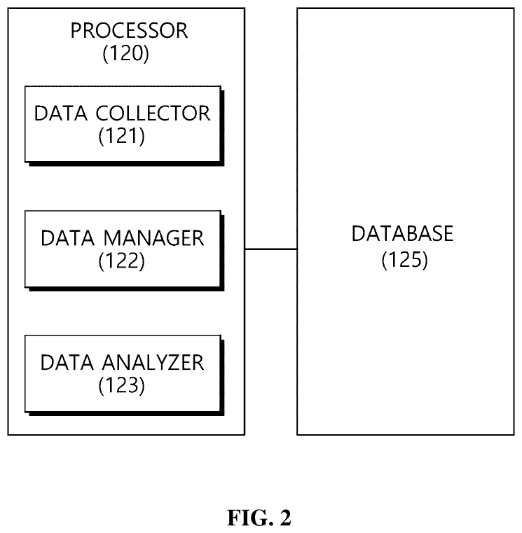

FIG. 2 is a diagram illustrating the detailed configuration of the wallet address management apparatus of FIG. 1 according to an embodiment of the present disclosure.

Referring to FIGS. 1 and 2, the wallet address management apparatus 12 includes a processor 120 and a database 125. The processor 120 includes a data collector 121, a data manager 122, and a data analyzer 123.

The data collector 121 may receive a request to register a risky wallet address from the plurality of virtual asset exchange servers 11. Or, the data collector 121 may receive a request to register a risky wallet address from the plurality of public institution servers 13. Or, the data collector 20 may receive a request to register a risky wallet address from the plurality of financial institution servers 14. As another example, the data collector 121 may collect risky wallet addresses from a surface web, a deep web, a dark web, an SNS, etc., the wallet addresses which cannot be collected from the plurality of virtual asset exchange servers 11, the plurality of public institution servers 13, and the plurality of financial institution servers 14.

The data manager 122 manages the risk statuses of wallet addresses for a plurality of affiliated virtual asset exchanges.

The data manager 122 stores a plurality of risky wallet addresses, which are collected through the data collector 121, in the database 125. At this point, the collection sources include a plurality of virtual asset exchange servers, a plurality of financial institution servers, a plurality of public institution servers, web pages (a surface web, a deep web, a dark web, a social networking service (SNS)), etc.

Afterwards, when a query request for a specific wallet address is received from a specific virtual asset exchange server, the data manager 122 may query the database 125 for a plurality of risky wallet addresses stored in the database 125 to determine whether the specific wallet address is a risky address and may respond to the specified virtual asset exchange server with a query result.

The database 125 serves as various storage media to store information generated during the operation of the processor 120 or information and commands necessary for the operation of the processor 120. The database 125 stores a plurality of risky wallet addresses collected through the data collector 121.

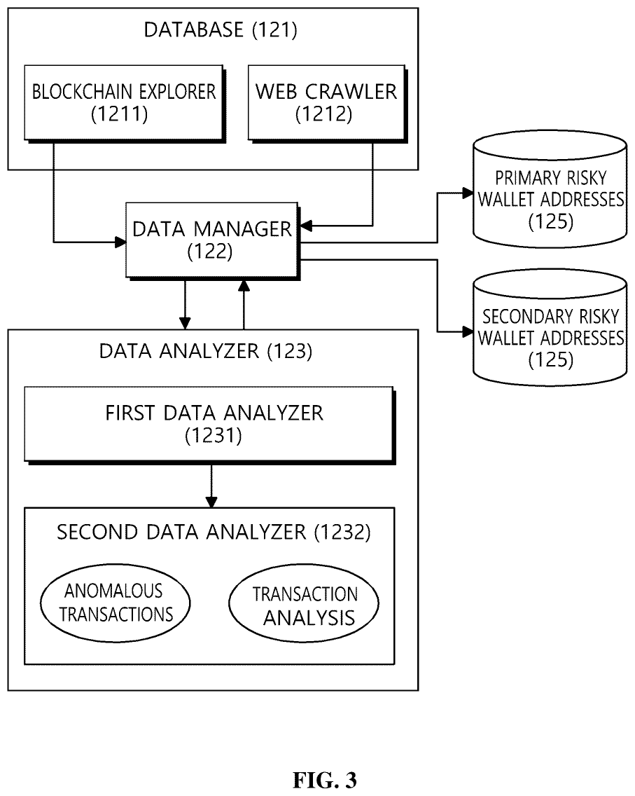

FIG. 3 is a diagram illustrating the detailed configuration of a processor according to an embodiment of the present disclosure.

Referring to FIGS. 2 and 3, the data collector 121 of the processor 12 includes a blockchain explorer 1211 and a web crawler 1212.

The blockchain explorer 1211 may collect wallet address information from a wallet address. The wallet address information includes transaction history, transaction volume, transaction target, and transaction time stored in blockchains. The web crawler 1212 collects wallet addresses exposed on web pages. At this point, the web pages may include a dark web, a surface web, an SNS such as Telegram, etc.

The data analyzer 123 analyzes a plurality of wallet addresses collected by the data collector 121 and filters out risky wallet addresses. The data analyzer 123 may include a first data analyzer 1231 and a second data analyzer 1232.

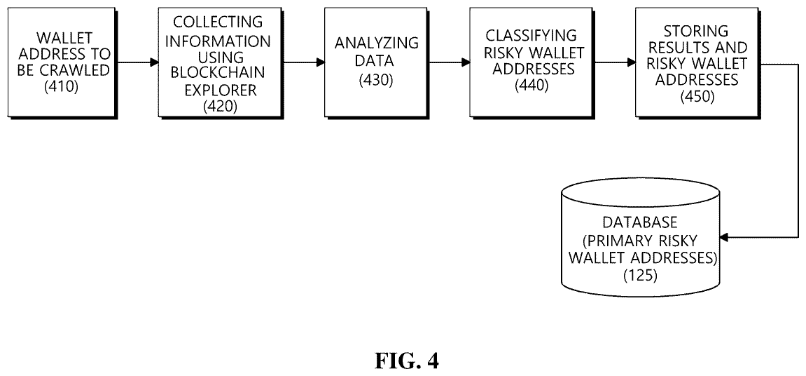

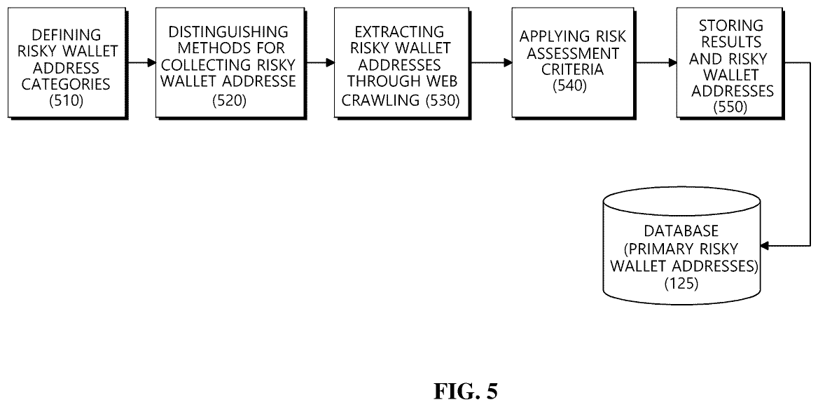

The first data analyzer 1231 analyzes and classifies wallet address information. At this point, the first data analyzer 1231 may extract primary risky wallet addresses and store the extracted primary risky wallet addresses in the database 125 through the data manager 122, as shown in the drawing, and may store wallet address information, which can be identified from the primary risky wallet addresses, in the database 125. A process of extracting primary risky wallet addresses by the first data analyzer 1231 will be described later with reference to FIGS. 4 and 5.

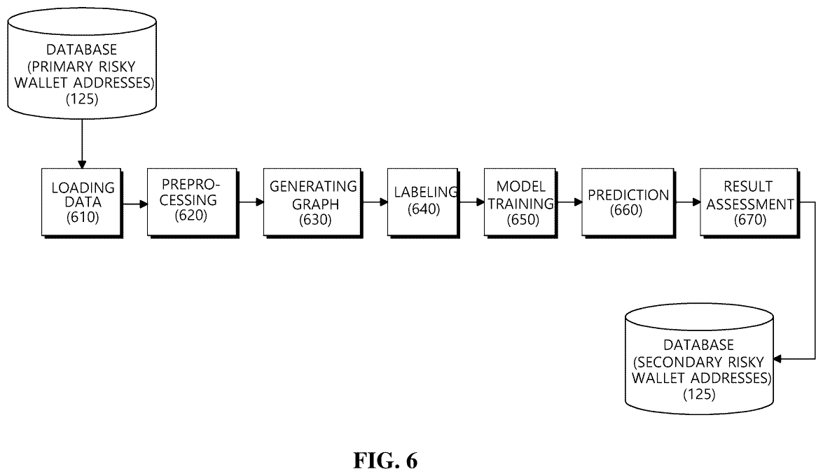

The second data analyzer 1232 loads the primary risky wallet addresses, analyzes transaction history information of the primary risky wallet addresses, and extracts secondary risky wallet addresses using a risk prediction model. For example, the second data analyzer 1232 may analyze transaction history of previous transactions to determine illegal and fraudulent activities and transactions with addresses previously classified as risky. Alternatively, the second data analyzer 1232 may identify anomalous transactions, such as cases where a large number of coins are traded in a short period or where multiple transactions occur. A process of extracting secondary risky wallet addresses using a risk prediction model by the second data analyzer 1232 will be described later with reference to FIG. 6.

FIG. 4 is a diagram illustrating a process of extracting primary risky wallet addresses by analyzing information collected through a blockchain explorer according to an embodiment of the present disclosure.

Referring to FIGS. 1, 3, and 4, the data collector 121 selects a target wallet address to be crawled (410). The target wallet address may include a wallet address held by a target group (such as a criminal, a dangerous individual, an organization, etc.), a wallet address associated with a past criminal case, a wallet address connected to harmful content, etc.

Next, the data collector 121 collects wallet address information stored on blockchains from the selected wallet address using the blockchain explorer 1211 (420). The wallet address information includes transaction history, transaction volume, transaction target, transaction time, etc.

Next, the first data analyzer 1231 analyzes risky behavior patterns using the collected wallet address information (430). The anomalous transactions include, for example, transactions involving large amounts or numerous transactions made periodically or over a short period, and transactions with wallet addresses which are previously classified as risky.

Next, the first data analyzer 1231 classifies the primary risky wallet addresses using the analyzed risk behavior patterns (440). At this point, the first data analyzer 1231 may categorize the wallet addresses, which have been classified by risk, according to risk levels.

Next, the first data analyzer 1231 stores the categorized primary risky wallet addresses in the database through the data manager 122 (450). At this point, the first data analyzer 1231 may find additional risk factors and patterns and define the found factors and patterns as final training data.

FIG. 5 is a diagram illustrating a process of extracting primary risky wallet addresses by analyzing information collected through a web crawler according to an embodiment of the present disclosure.

Referring to FIGS. 1, 3, and 5, the data collector 121 defines risky wallet address categories (510). The categories may include blacklist, cybercrime, financial crime, other crimes, money laundering risk, general crime, trade and economic crime, tax crime, etc.

Next, the data collector 121 distinguishes methods for collecting risky wallet addresses (520). For example, for the categories of blacklist, cybercrime, financial crime, and other crimes, risky wallet addresses may be collected through the web crawler 1212. For the money laundering risk category, risky wallet addresses may be collected by analyzing transaction history of collected wallet addresses. For categories such as general crime, trade and economic crime, and tax crime, collection through web crawling is not possible. In this case, risky wallet addresses may be collected by accessing public institutions' websites.

Next, for the categories of blacklist, cybercrime, financial crime, and other crimes, the first data analysis unit 1231 automatically extracts primary risky wallet addresses using search keywords for respective risky wallet address categories through the web crawler 1212 (530). At this point, Surface web, dark web, and SNS may be used.

Next, the first data analyzer 1231 may define risk assessment criteria by applying relevant laws and regulations of related institutions based on the types of crime associated with the extracted primary risky wallet addresses, quantify the risk of each wallet address, and assign a weight to a corresponding wallet address, and extract high-risk wallet addresses (540).

Next, the first data analyzer 1231 stores the extracted primary risky wallet addresses in the database 125 through the data manager 122 (550).

FIG. 6 is a diagram illustrating a process of extracting secondary risky wallet addresses according to an embodiment of the present disclosure.

Referring to FIGS. 1, 3, and 6, the second data analyzer 1232 loads the collected primary risky wallet addresses (610).

Next, the second data analyzer 1232 performs preprocessing to extract transaction history information, such as the sender, receiver, amount, fees, transaction time, previous transaction block, digital signature, and transaction hashes (620).

Next, the second data analyzer 1232 generates a graph to train a model (630). In the graph generating step 630, the second data analyzer 1232 may generate graph nodes for all wallet addresses and transaction information and add a connection line for each transaction information.

Next, the second data analyzer 1232 adds labeling to be used to train threatening behavior patterns (640). For example, labels may be added to wallet addresses where large transactions occur.

Next, the second data analyzer 1232 trains the model (650). In the model training step 650, the second data analyzer 1232 may provide training data to the model, and the model may detect threatening behavior patterns.

Next, the second data analyzer 1232 predicts a risk potential of a new wallet address using the trained model (660). In the prediction step 660, the second data analyzer 1232 may input a wallet address not learned by the model and predict whether the corresponding address is associated with threat behavior patterns.

Next, the second data analyzer 1232 assesses a prediction result generated by the model (670). In the assessment step 670, the second data analyzer 1232 may verify whether the prediction generated by the model is accurate and then assess the performance of the model.

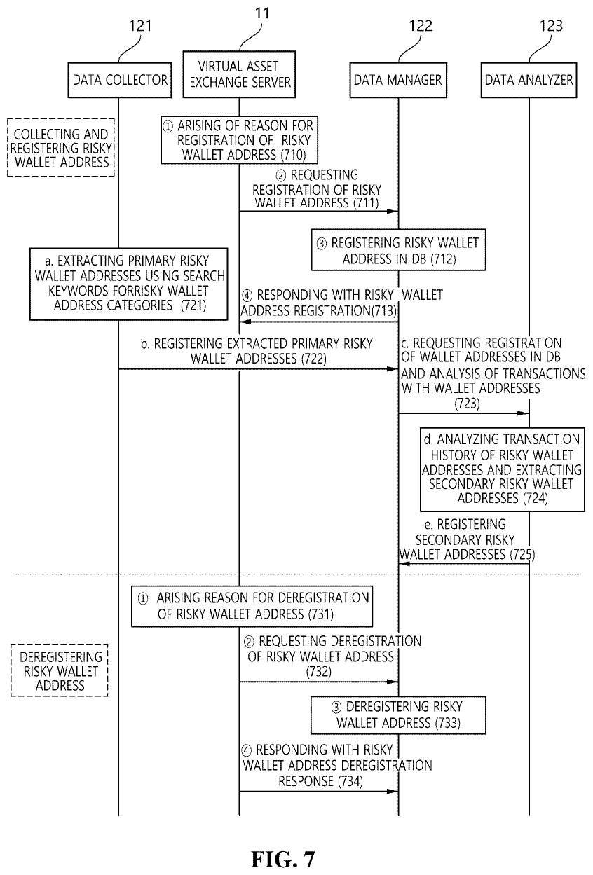

FIG. 7 is a diagram illustrating a wallet address registration and deregistration process according to an embodiment of the present disclosure.

A process of registering risky wallet addresses will be described later with reference to FIGS. 2 and 7.

When a risky wallet address reason arises, the virtual asset exchange server 11 separates registration reason codes and prohibits any virtual asset transaction related to a corresponding wallet address (710).

Next, the virtual asset exchange server 11 requests risky wallet address registration from the data manager 122 (711). At this point, a coin name, a wallet address, a registration reason code, etc., may also be transmitted.

Next, the data manager 122 registers a risky wallet address as requested from the virtual asset exchange server 11 (712) and manages the wallet address by exchange code.

Next, the data manager 122 transmits a risky wallet address registration response message to the virtual asset exchange server 11 (713).

Furthermore, the data collector 121 extracts primary risky wallet addresses using search keywords for respective risky wallet address categories through web crawling (721).

Next, the data collector 121 transmits the extracted primary risky wallet addresses to the data manager 122, and the data manager 122 stores the extracted primary risky wallet addresses in the database (722).

Next, the data manager 122 registers the registered primary risky wallet addresses in the database and requests the data analyzer 123 to analyze transaction history of the primary risky wallet addresses (723).

Next, the data analyzer 123 analyzes the transaction history of the primary risky wallet addresses and extracts the secondary risky wallet addresses (724).

Next, the data analyzer 123 transmits the extracted secondary risky wallet addresses to the data manager 122 and stores the extracted secondary risky wallet addresses in the database (725).

Hereinafter, a process of deregistering a risky wallet address will be described.

When a reason for deregistering a registered risky wallet address arises, the virtual asset exchange server 11 lifts the prohibition on transactions with the corresponding wallet address (731).

Next, the virtual asset exchange server 11 requests the deregistration of the risky wallet address from the data manager 122 (732). At this point, a registration transaction number and the like may also be transmitted.

Next, the data manager 122 deregisters the risky wallet address (733) and manages the wallet address by exchange code (733).

Next, the data manager 122 transmits a risky wallet address deregistration response message to the virtual asset exchange server 11 (734).

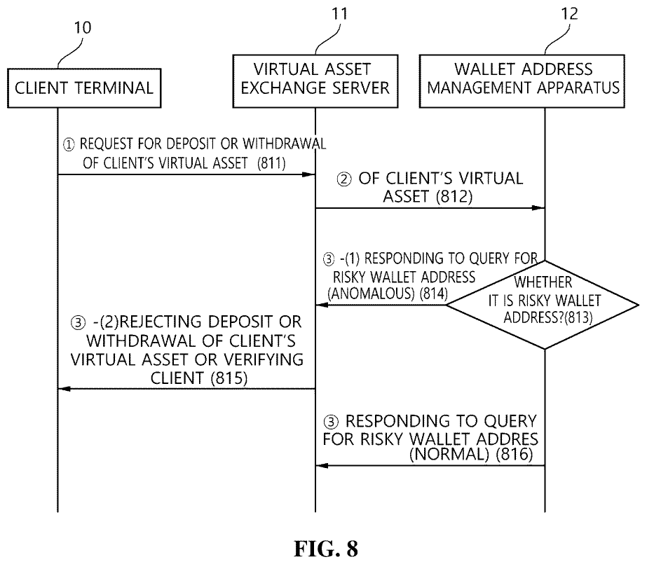

FIG. 8 is a diagram illustrating the flow of a method for providing a wallet address query service according to an embodiment of the present disclosure.

Referring to FIGS. 1 and 8, the client terminal 10 transmits a client virtual asset transaction request to the virtual asset exchange server 11 (811).

Next, the virtual asset exchange server 11 requests the wallet address management apparatus 12 to query a specific wallet address (812).

Next, the wallet address management apparatus 12 determines whether the specific wallet address is risky (813) by querying the risky wallet addresses stored in the database. The risky wallet addresses stored in the database are wallet addresses collected from a plurality of virtual asset exchange servers, a plurality of financial institution servers, a plurality of public institution servers, and web pages (a surface web, a deep web, a dark web, an SNS), etc. (813).

Next, if the specific wallet address is risky, a response message indicating that the specific wallet address is risky is transmitted to the virtual asset exchange server 11 (814). Then, the virtual asset exchange server 11 may reject any virtual asset transaction or request client verification from the client terminal 10 (815).

In contrast, if the specific wallet address is not risky, a response message indicating that the specific wallet address is not risky is sent to the virtual asset exchange server 11 (816).

The response message may include a response value (normal, error), an error code, a blacklist registration institution code, etc.

As described above, in the high-risk virtual asset wallet address management apparatus and the method for providing a high-risk wallet address query service according to the present disclosure, it is possible to query the risk status of a wallet address for virtual asset transactions when a client requests a virtual asset transfer to a virtual asset exchange, and to provide a query result.

Accordingly, it is possible to preemptively prevent the fraudulent use of an e-wallet address detected with an anomalous transaction and to protect a virtual asset exchange from financial crime risks. At this point, the wallet address management apparatus may manage risky wallet addresses registered not only by the virtual asset exchange used by the client but also by all virtual asset exchanges affiliated with the apparatus and then notify these virtual asset exchanges of the risk statuses of the risky wallet addresses, thereby providing better protection against financial crime risks.

In addition, the high-risk wallet address management apparatus according to one embodiment may collect risky wallet addresses through web crawling from a dark web, a surface web, a social networking service (SNS), etc. In addition, since risky wallet addresses can be collected from a plurality of public institutions, a plurality of financial institutions, etc., and notified to virtual asset exchanges, it is possible to protect the virtual asset exchanges better against financial crime risks.

Furthermore, the wallet address management apparatus according to one embodiment may extract primary risky wallet addresses using search keywords for respective risky wallet address categories, and may extract secondary risky wallet addresses through analysis of transaction history information of the primary risky wallet addresses and a risk prediction model. Accordingly, due to the risky wallet address analysis process, it is possible to extract risky wallet addresses more accurately.

Embodiments of the present disclosure have been described. It will be understood by those skilled in the art that various changes in form and details may be made therein without departing from the spirit and scope of the present disclosure. Therefore, the disclosed embodiments should be considered as illustrative rather than restrictive. The scope of the present disclosure is defined not by the detailed description of the present disclosure but by the appended claims, and all differences within the scope will be construed as being included in the present disclosure.

1. A wallet address management apparatus comprising:
a data collector configured to collect a plurality of risky wallet addresses from a plurality of virtual asset exchange servers; and
a data manager configured to store the plurality of collected risky wallet addresses in a database, and upon receiving a query request for a specific wallet address from a specific virtual asset exchange server, to determine whether the specific wallet address is risky by querying the database for the plurality of risky wallet addresses collected from various virtual asset exchange servers, and to respond to the specific virtual asset exchange server with whether the specific wallet address is risky.

2. The wallet address management apparatus of claim 1,
wherein the data collector collects a plurality of risky wallet addresses from a plurality of financial institution servers and a plurality of public institution servers, and
wherein the data manager stores the plurality of collected risky wallet addresses in the database, and upon receiving a query for a specific wallet address from a specific virtual asset exchange server, determines whether the specific wallet address is risky by querying the database for the plurality of risky wallet addresses collected from the plurality of financial institution servers and the plurality of public institution servers, and responds to the specific virtual asset exchange server with whether the specific wallet address is risky.

3. The wallet address management apparatus of claim 1, wherein the data collector collects a plurality of high-risk wallet addresses from a plurality of web pages including at least one of a surface web, a deep web, a dark web, and a social networking service (SNS) through web crawling, and
wherein the data manager stores the plurality of collected risky wallet addresses in the database, and upon receiving a query for a specific wallet address from a specific virtual asset exchange server, determines whether the specific wallet address is risky by querying the database for the plurality of risky wallet addresses collected from the plurality of web pages, and responds to the specific virtual asset exchange server with whether the specific wallet address is risky.

4. The wallet address management apparatus of claim 1, wherein the data collector comprises:
a blockchain explorer configured to collect wallet information from a selected wallet address, including transaction history, transaction volume, transaction recipient, and transaction time stored in block chains; and
a web crawler configured to collect wallet addresses exposed on web pages.

5. The wallet address management apparatus of claim 1, wherein the data collector defines risky wallet address categories and distinguishes methods for collecting risky wallet addresses so that a first category involves collecting risky wallet addresses through a web crawler, a second category involves collecting risky wallet addresses by analyzing transaction history of the collected wallet addresses, and a third category involves collecting risky wallet addresses by accessing public institution websites.

6. The method of claim 1, further comprising a data analyzer configured to analyze a plurality of wallet addresses collected by the data collector and filter out risky wallet addresses.

7. The method of claim 6, wherein the data analyzer comprises a first data analyzer configured to analyze risk behavior patterns using the collected wallet address information, classify primary risky wallet addresses based on the analyzed risk behavior patterns, categorize the classified wallet addresses by risk level, and store the categorized primary risky wallet addresses in the database.

8. The method of claim 6, wherein the data analyzer comprises a first data analyzer configured to extract primary risky wallet addresses using search keywords for respective risky wallet address categories, including blacklist, cybercrime, financial crime, and other crime categories, and store the classified primary risky wallet addresses in the database.

9. The method of claim 8, wherein the first data analyzer defines risk assessment criteria by applying relevant laws and regulations of related institutions based on suspected crime types associated with the extracted primary risky wallet addresses and, based on the risk assessment criteria, quantifies risks of the wallet addresses and assigns weights to the wallet addresses.

10. The method of claim 6, wherein the data analyzer comprises a second data analyzer configured to load primary risky wallet addresses from the database, analyze transaction history information of the primary risky wallet addresses, and extract secondary risky wallet addresses using a risk prediction model.

11. A method for providing a wallet address query service using a wallet address management apparatus which manages a plurality of wallet addresses for virtual asset transactions, the method comprising:
receiving requests to register a risky wallet address from a plurality of virtual asset exchange servers and registering risky wallet addresses;
through web crawling, extracting primary risky wallet addresses using search keywords for risky wallet address categories, including blacklist, cybercrime, financial crime, and other crime categories;
storing and registering the extracted primary risky wallet addresses in a database; and
loading the primary risky wallet addresses registered in the database, analyzing transaction history information of the primary risky wallet addresses, extracting secondary risky wallet addresses using a risk prediction model, and storing the extracted secondary risky wallet addresses in the database.

12. A method for providing a wallet address query service using a wallet address management apparatus which manages a plurality of wallet addresses for virtual asset transactions, the method comprising:
extracting primary risky wallet addresses using search keyword for respective risky wallet address categories, including blacklist, cybercrime, financial crime, and other crime categories, and storing the extracted primary risky wallet addresses in a database;
loading the primary risky wallet addresses registered in the database, analyzing transaction history information of the primary risky wallet addresses, and extracting secondary risky wallet addresses using a risk prediction model;
receiving requests to register a risky wallet address from a plurality of virtual asset exchange servers and registering risky wallet addresses;
receiving a query request for a specific wallet address from a specific virtual asset exchange server;
determining whether the specific risky wallet address is a primary or secondary risky wallet address, by querying the database for the registered risky wallet addresses from the plurality of virtual asset exchange servers; and
responding to the specific virtual asset exchange server with whether the specific wallet address is risky.

13. The method of claim 12, further comprising receiving requests to register a risky wallet address from a plurality of public institution servers and a plurality of financial institution servers and registering risky wallet addresses,
wherein, in determining whether the specific wallet address is risky, the registered risky wallet addresses from the plurality of public institution servers and the plurality of financial institution servers are queried to determine whether the specific wallet address is risky.

14. The method of claim 12, further comprising collecting risky wallet addresses through web crawling,
wherein, in determining whether the specific wallet address is risky, the risky wallet addresses collected through the web crawling are queried to determine whether the specific wallet address is risky.

15. The method of claim 12, further comprising:
extracting primary risky wallet addresses using search keywords for the respective risky wallet address categories through web crawling; and
storing and registering the extracted primary risky wallet addresses in the database,
wherein, in determining whether the specific wallet address is risky, the primary risky wallet addresses stored in the database are queried to determine whether the specific wallet address is risky.

16. The method of claim 15, further comprising extract secondary risky wallet addresses by analyzing transaction history of the registered primary risky wallet addresses, and storing the extracted secondary risky wallet addresses in the database,
wherein, in determining whether the specific wallet address is risky, the secondary risky wallet addresses stored in the database are queried to determine whether the specific wallet address is risky.
